(19) United States
(12) Patent Application Publication
(10) Pub. No.: US 2024/0426398 A1
(43) Pub. Date: Dec. 26, 2024

(54) Apparatus and Method for Transporting and Laying Cables and Conduits for Cables for Underground Installation

(71) Applicant: JT Lewellen, Houston, TX (US)

(72) Inventor: JT Lewellen, Houston, TX (US)

(21) Appl. No.: 18/662,880

(22) Filed: May 13, 2024

Related U.S. Application Data
(63) Continuation-in-part of application No. 18/111,877, filed on Feb. 20, 2023, now abandoned.
Application No. 18/111,877 is a continuation-in-part of application No. 17/557,054, filed on Dec. 21, 2021, now Pat. No. 11,598,450.
(60) Provisional application No. 63/469,441, filed on May 28, 2023.
(60) Provisional application No. 63/463,863, filed on May 3, 2023.
(60) Provisional application No. 63/134,513, filed on Jan. 6, 2021.

(51) Int. Cl. F16L 1/06; B60P 3/00; E21B 7/20

(52) U.S. Cl. CPC F16L 1/065; B60P 3/00; E21B 7/20

(57) ABSTRACT

Apparatus for transporting and laying cable for electrical power or telecommunication signals. The apparatus has a mobile unit with support configured to align weight of the cable with the longitudinal central axis of the mobile unit. Caterpillar tracks carry and move the apparatus, which can be controlled remotely. The apparatuses can transport and lay cable at a delivery location by cooperating in tandem formation while maintaining alignment of the weight of the cable with the longitudinal central axis of each of the mobile units.

### RELATED APPLICATIONS

This application claims priority from U.S. Provisional Patent Application No. 63/469,441, filed May 28, 2023, pending, and U.S. Provisional Patent Application No. 63/463,863, filed May 11, 2023, pending, and U.S. patent application Ser. No. 18,111,877, filed Feb. 20, 2023, pending, which is a continuation in part of U.S. Pat. No. 11,598,459, issued Mar. 7, 2023, and which claims the benefit of U.S. Provisional Patent Application Ser. No. 63/134,513, filed Jan. 6, 2021, now expired, and all of which are incorporated herein by reference to every extent that may be allowed.

### BACKGROUND

The present invention relates to cables and conduits for cables used to carry electricity or electrical power, radio frequency signals, and telecommunication signals such as for example data, voice and video communications for phones, television, and security systems and the like.

More particularly, the present invention relates to installation of cables and conduits for cables and methods and apparatuses used for that installation. Most specifically, the present invention relates to cable laying apparatuses and methods for transporting and laying cables and cable conduits for installing cables underground.

### SUMMARY

The present invention provides an apparatus for transporting and laying underground a cable and/or a conduit for containing a cable or combination of cables to be used for transportation or carriage of electricity/electrical power, or telecommunication signals. The apparatus comprises a mobile unit having a longitudinal central axis and a front end and a rear end for receiving and unloading the cable or cable conduit (which said conduit may or may not contain a cable or a combination of cables during said transportation and installation) onto and off of the mobile unit. Said front end and rear end of the mobile unit can be used interchangeably-or vis versa.

The mobile unit of the apparatus of the invention has at least one support configured to align a weight of the cable or cable conduit with the longitudinal central axis of the mobile unit. That alignment should occur upon the mobile unit's receiving the cable or cable conduit and should continue or be maintained during the holding, transporting and unloading of the cable or cable conduit at a delivery location.

The apparatus also has at least one cable or cable conduit holder with a low-friction surface extending from or associated with at least one support for facilitating the receiving, holding, transporting and unloading of said cable or cable conduit on the mobile unit. In one embodiment, the low-friction surface can be provided with rollers. In another embodiment, the low-friction surface can be provided with lubricant(s).

Caterpillar track(s) or tank treads carry and move the apparatus of the invention and an engine or motor is configured to drive the track or tank treads. In one embodiment, this movement can be controlled remotely. That is, in one embodiment, the apparatus has a programmable controller that allows remote control of the caterpillar track(s) or tank treads, the engine, the mobile unit, the support(s), and/or the cable or cable conduit holder(s) of the apparatus. Similar “dummy” or “auxiliary” engineless units can be pulled or pushed by one or more apparatus of the invention working or operating in tandem for carrying longer lengths of cable or cable conduit than a single unit can support or carry.

The apparatus of the invention can further, in one embodiment, comprise an optional ramp for attaching to an end (front or back) of the mobile unit to aid the uploading or unloading of the cable or cable conduit.

At least one support on the mobile unit is preferably adjustable such that a height position of that support is adjustable with respect to the mobile unit and the cable or cable conduit holder. In one embodiment having multiple supports that are adjustable or extendable, the adjustments can be made such that the cable or cable conduit or cable or cable conduit holder tilts to enable gravity to aid unloading of the cable or cable conduit.

The present invention further provides methods of using the apparatuses of the invention for transporting and laying cable or cable conduit at a delivery location for placement and/or underground installation. Such delivery location can be the intended cable or cable conduit location itself, above ground, in a ditch, or underground and accessed in cooperation with directional drilling equipment, although the cable or cable conduit containing cable will ultimately be buried underground when the installation is complete. Alternatively, such delivery location can be near such intended cable or cable conduit location for providing ready access of cable or cable conduit for constructing the cable or cable underground installation.

The apparatuses of the invention (including mobile units and auxiliary units, which are also mobile but engineless) can be positioned in tandem formation for cooperation in receiving, moving, and unloading cable or cable conduits. At such times, alignment of the weight of the cable or cable conduit with the longitudinal central axis of each of the mobile units and auxiliary units is maintained.

### BRIEF DESCRIPTION OF THE DRAWINGS

The invention can better be understood by reference to the following detailed description when read in conjunction with the accompanying drawings, which are not drawn to scale but are intended to be illustrative, wherein:

FIG. 1 is an illustration of a first embodiment of the apparatus of the invention shown from an end view having an enclosed, protective encasement cable or cable conduit holder supported on the mobile unit of the apparatus of the invention.

FIG. 2 is an illustration of an alternative or second embodiment of the apparatus of the invention shown from a side view having multiple 360 degree “O”-shaped or similarly closed cradle cable or cable conduit holders each extending from respective multiple supports on the mobile unit of the apparatus of the invention, and showing an optional removable ramp in place for use.

FIG. 3 is an illustration of an alternative or third embodiment of the apparatus of the invention shown from an end view having at least one open “C”-shaped cradle or cable conduit holder extending from a support on the mobile unit of the apparatus of the invention.

FIG. 4 is an illustration of the top view of the embodiment of the apparatus shown in FIG. 3, further showing multiple open “C”-shaped cradle or cable conduit holders and an optional ramp in place for use.

FIG. 5 is an illustration of an alternative or fourth embodiment of the apparatus of the invention shown from an end view having at least one horseshoe shaped cradle hanging from a gantry extending over at least a portion of the mobile unit and extending from at least one support on the mobile unit of the apparatus of the invention.

FIG. 6 is an illustration of one embodiment of the three apparatuses of the invention (also shown in FIG. 2) working in tandem to hold and carry or transport to a delivery location for cable or cable conduit placement a cable or cable conduit after receipt of the cable or cable conduit in one example application of the method of the invention.

FIG. 7 is an illustration of the three apparatuses of the invention in the application shown in FIG. 6 unloading the cable or cable conduit at the delivery location.

FIG. 8 is an illustration of one embodiment of the multiple apparatuses of the invention (also shown in FIGS. 2, 6 and 7) working in tandem to carry and transport a cable or cable conduit to a delivery location for placement through directional drilling under a body of water in another example application of the method of the invention.

FIG. 9 is a bird's eye or overhead view of the scene in FIG. 8.

FIG. 10 is an illustration of another embodiment of multiple apparatuses of the invention (also shown in FIG. 3) working in tandem to hold and carry or transport to a delivery location for cable or cable conduit placement a cable or cable conduit after receipt of the cable or cable conduit or cable or cable conduit in another example application of the method of the invention.

FIG. 11 is an illustration of the multiple apparatuses of the invention in the example shown in FIG. 10 unloading the cable or cable conduit at the delivery location.

FIG. 12 is an illustration of an alternative embodiment to the first embodiment of the apparatus of the invention as shown in FIG. 1, but from a side view, having an enclosed, protective encasement-type of cable or cable conduit holder supported on the mobile unit of the apparatus of the invention, but in the form of a square or rectangular cage for receiving and holding the cable or cable conduit with interior rollers on the sides of the cage and above and below the cable or cable conduit in the cage for movement of the cable or cable conduit onto and off of the apparatus.

FIG. 13 is an end view of the apparatus shown in FIG. 12, particularly showing the rollers on the interior sides of the cage that are not shown in FIG. 12.

FIG. 14 is a perspective view of an alternative embodiment of the apparatus shown in FIGS. 12 and 13, where the cage for holding and transporting cable or cable conduit has rollers only on the sides and bottom and not at the top of the cage interior,

FIG. 15 is a side view of the apparatus shown in FIG. 14.

FIG. 16 is an end view of the apparatus shown in FIGS. 14 and 15.

FIG. 17 is a perspective view of the cage of the apparatus shown in FIGS. 14, 15, and 16.

FIG. 18 is a side view of the cage shown in FIG. 17.

FIG. 19 is an end view of the cage shown in FIGS. 17 and 18.

FIG. 20 is a blown apart view of the cage shown in FIGS. 17, 18, and 19.

FIG. 21 is a side view of an alternative but similar embodiment to the apparatus shown in FIG. 2, having multiple 360 degree “O”-shaped or similarly closed cradle cable or cable conduit holders each extending from respective multiple supports on the mobile unit of the apparatus of the invention, but where the mobile unit moves across ground on a sled rather than on caterpillar or tank treads and is pulled or pushed by another apparatus of the invention or an auxiliary apparatus, as the apparatus in FIG. 21 does not have an engine.

FIG. 22 is a schematic of three embodiments of the apparatus of the invention showing their use in tandem with each other in various configurations for methods of the invention, that is, with several different embodiments of the apparatus of the invention in use together.

FIG. 23 is still another alternative embodiment of the apparatus of the invention where the cable or cable conduit holder is comprised of a pair of large rollers in the form akin to tank treads which sandwich the cable or cable conduit between them for transport atop the mobile unit of the apparatus of the invention.

### DETAILED DESCRIPTION

The present invention provides an apparatus for use in transporting cable or cable conduit and laying cable or cable conduit in a trench, beside a trench or at or otherwise above ground level, or near or under a body or water such as in association with directional or horizontal subterranean drilling. The present invention further comprises a method using apparatus(es) of the invention for transporting and laying cable or cable conduit, for laying or installing such cable or cable conduit underground.

The apparatus of the invention can be remotely controlled, and can require relatively little or no need for use of a right-of-way or easement beyond the amount where the cable or cable conduit comprising one or more cables is to be buried underground, and thereby minimizing environmental interference from the installation. In use, an apparatus of the invention can receive, lift or lower a cable or cable conduit, carry such cable or cable conduit to and/or hold it at a desired location, and then either transfer the cable or cable conduit to another apparatus of the invention (whether it comprises a mobile unit or an auxillary unit) or lower the cable or cable conduit into place at the desired location for underground installation. For such transfer or delivery, the apparatus of the invention can be caused to employ controlled assistance from gravity, enabling the apparatus to function efficiently.

The apparatus of the present invention is preferably sized to be no more than about twelve inches wider than and preferably no wider than, or even up to about three to six inches less than, the width of the cable or cable conduit the apparatus is intended to carry. In one embodiment the width of the apparatus of the present invention is adjustable or expandable. Sizing of the apparatus of the invention related to the size cable or cable conduit it is intended to carry enables the apparatus of the invention to be able to fit in a ditch or trench or other location in which the cable or cable conduit is to be placed for underground installation.

Considering the diameters of cable or cable conduit in existence today for underground placement, typically 12 inches and 24 inches in diameter, the apparatus of the invention is provided in two different sizes, one having a width of about twelve inches, and one having a width of about twenty four inches, These sizes are believed to provide general utility for most of the cable or cable conduits contemplated for underground placement currently. Wider conduits might be used for cable groupings of more than about two or three cables and a larger apparatus of the invention could be used accordingly.

With reference to the Figures, illustrations of the apparatus of the invention in different embodiments and uses or applications are provided, showing different cable or cable conduit holders for holding a cable or cable conduit on the mobile unit of the apparatus of the invention. In these illustrative examples, the same reference numerals may be used in more than one Figure. This reuse of a reference numeral in different Figures represents the same element in the different Figures, even though the Figures may illustrate different embodiments of the apparatus of the invention, indicating that such embodiments, albeit different, have some common or like elements.

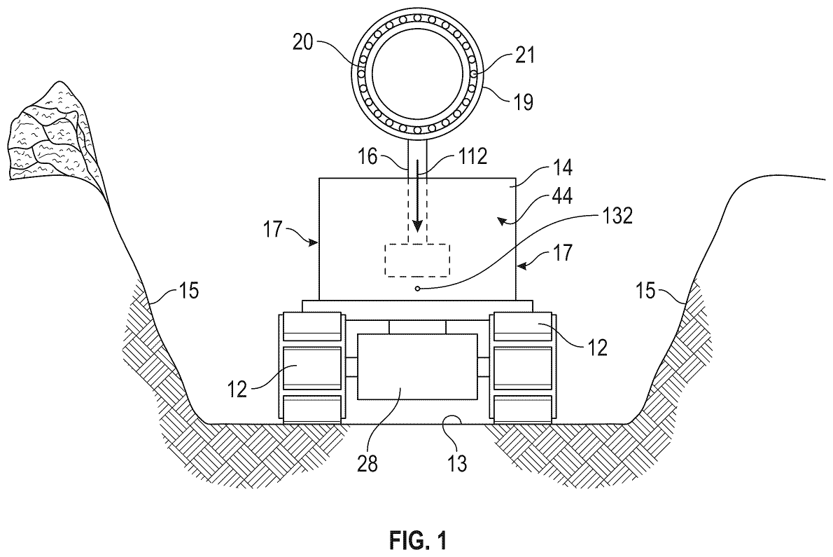

Referring to the Figures, depicting multiple embodiments of the apparatus of the invention (for illustration and not drawn to scale), the apparatus has caterpillar track or tank treads 12 for ease of movement of the apparatus on soil 13 as is commonly present in a cable or cable conduit environment for underground installation, which is typically a ditch or trench 15 (as shown in FIGS. 1, 3, 5, and 6) or right away adjacent the ditch or trench which may or may not have soil piled on it from digging of such ditch or trench. Wheels or skids could be substituted for the caterpillar track or tank treads 12, for use on harder ground in the environment such as, for example, pavement, or ice and/or mud respectively.

The caterpillar track or tank treads 12 carry a mobile unit 14 of the apparatus of the invention, which has at least one support 16 extending therefrom for supporting the cable or cable conduit 20. As used herein, the term “mobile unit” is understood to include a single unit or multiple units associated together to have the effect of a single unit for purposes of supporting the cable or cable conduit 20 or 60 on the apparatus of the invention. Some auxiliary units of the apparatus of the invention, which are substantially like the mobile units except lacking a motor or engine to independently drive the unit, may be substituted for mobile units so long as the auxiliary units are associated in tandem with mobile units capable of pulling or pushing the auxiliary units.

Support 16 has associated with it or extending from it a cable or cable conduit holder, which holds and supports the cable or cable conduit on the apparatus for receipt or uploading, transport, delivery and unloading and/or offloading of the cable or cable conduit or cable. The cable or cable conduit holder is configured to align weight 112 of cable or cable conduit 20, or cable or cable conduit section or segment 60, with the longitudinal central axis 132 of the apparatus of the invention as the apparatus receives and/or uploads, holds, transports, and transfers or unloads and/or offloads a cable or cable conduit. The longitudinal central axis 132 can be defined as the linear axis positioned equidistant from the two lateral sides 17 of the mobile unit 14. The weight 112 of the cable or cable conduit or cable or cable conduit segment is advantageously not carried to the side of apparatus of the invention. Weight 112 is represented in the FIGS. 1, 2, 3, and 5 with arrows.

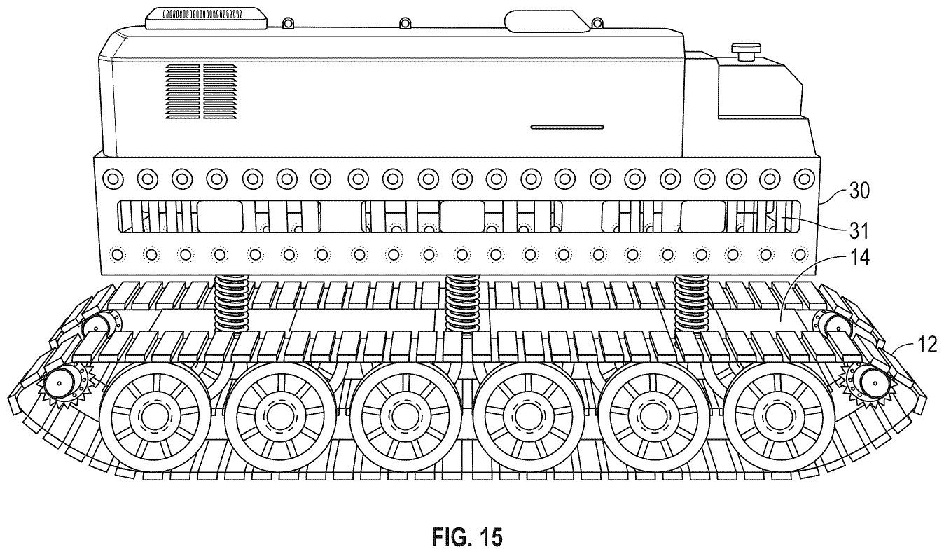

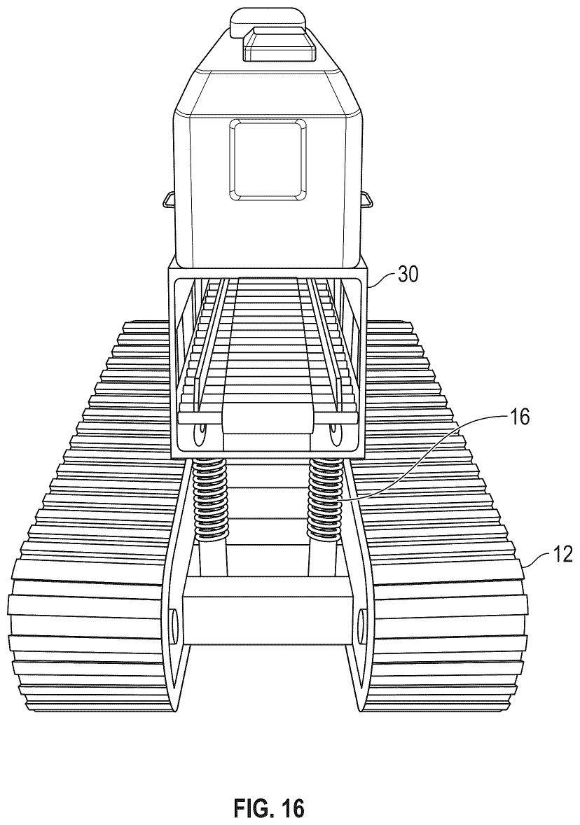

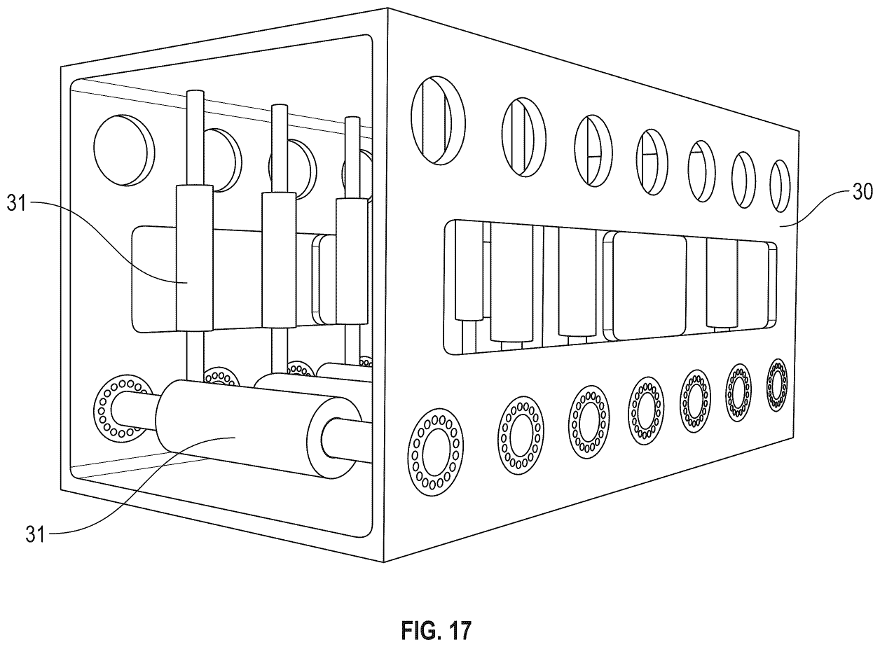

The cable or cable conduit holder on the apparatus of the invention has the functions discussed above, even though it can be different in different embodiments of the apparatus of the invention as illustrated in the FIGS. 1-5, 12-15, and 21-23 and discussed below, referring to different embodiments of cable or cable conduit holders 19, 22, 24, 25, 29, 30, 32, and 78 in FIGS. 1, 2, 3, 5, 12, 14, 21, and 23 respectively.

In one embodiment, the cable or cable conduit holder is comprised of an encasement 19 for cable or cable conduit 20 it encases, which such encasement can be a larger diameter encasing cable or cable conduit as shown in FIG. 1 having a length slightly less than or about the same as the cable or cable conduit 20, with interior rollers 21 about its interior circumference. This encasement cable or cable conduit holder 19 receives, protects, holds, and supports, the cable or cable conduit 20 while the interior rollers 21 help facilitate movement of the cable or cable conduit 20 during receipt or uploading and unloading the cable or cable conduit 20. In one embodiment, such encasement cable or cable conduit holder 19 of FIG. 1 can be removed and replaced with a different sized diameter but otherwise like or similar encasement cable or cable conduit holder so that the apparatus can be readily adapted for holding different diameter cable or cable conduits.

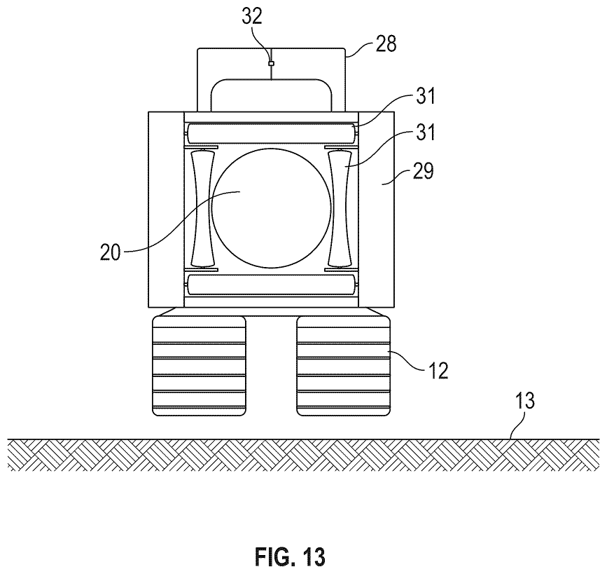

In another embodiment, similar to the encasement cable or cable conduit holder 19 illustrated in FIG. 1, a square or rectangular cage 29 is used to receive and hold the cable or cable conduit with cylindrical or longitudinal interior rollers 31 on the interior sides of the cage and above and below the cable or cable conduit in the cage as shown in FIGS. 12-13. These cylindrical or longitudinal rollers 31 also allow or provide for movement of the cable or cable conduit onto and off of the apparatus. Cage 29 is supported on the mobile unit 14 of the apparatus of the invention with adjustable supports (not shown in these illustrations but substantially like the support 16 in FIG. 1 that can raise and lower and/or tilt cage 29.

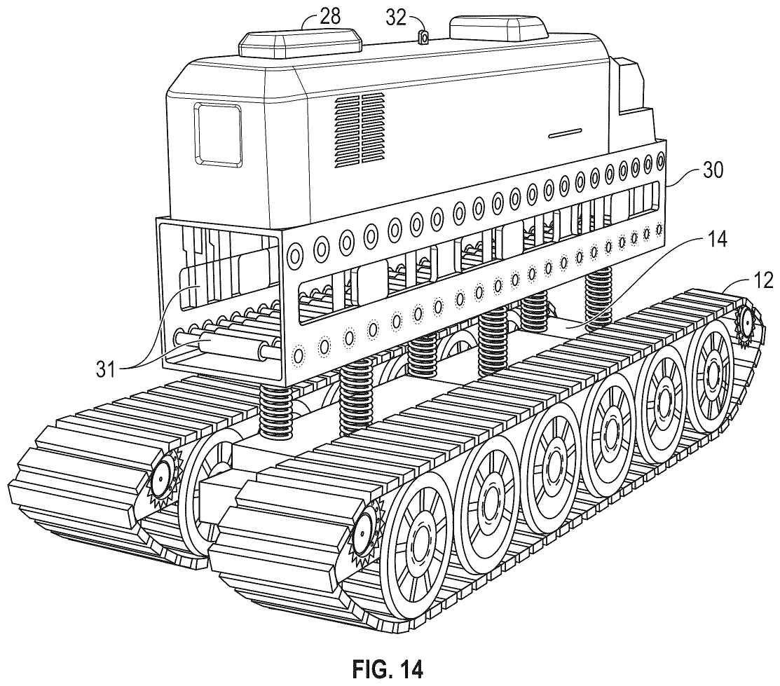

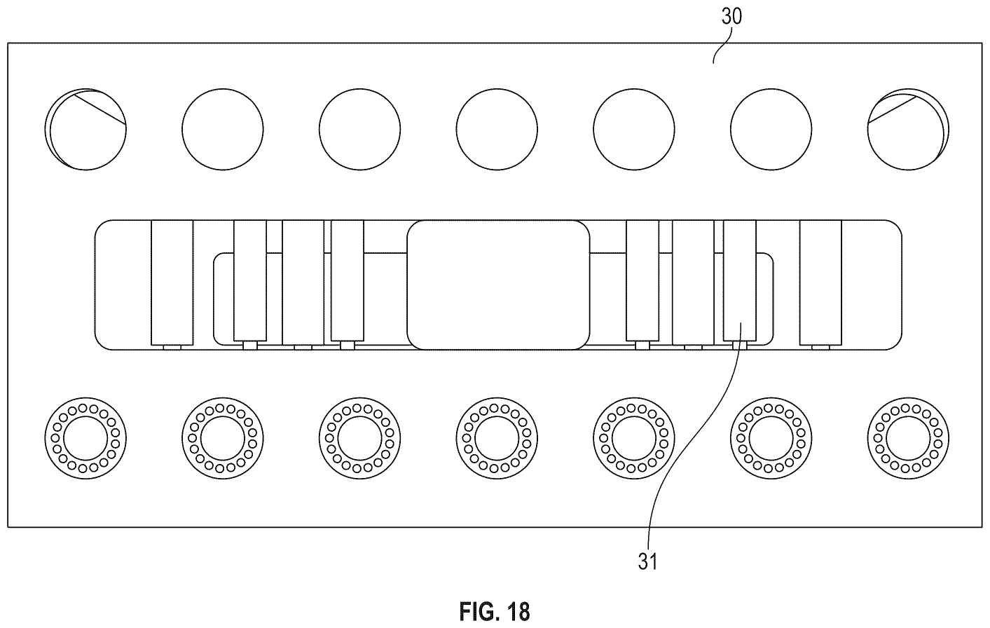

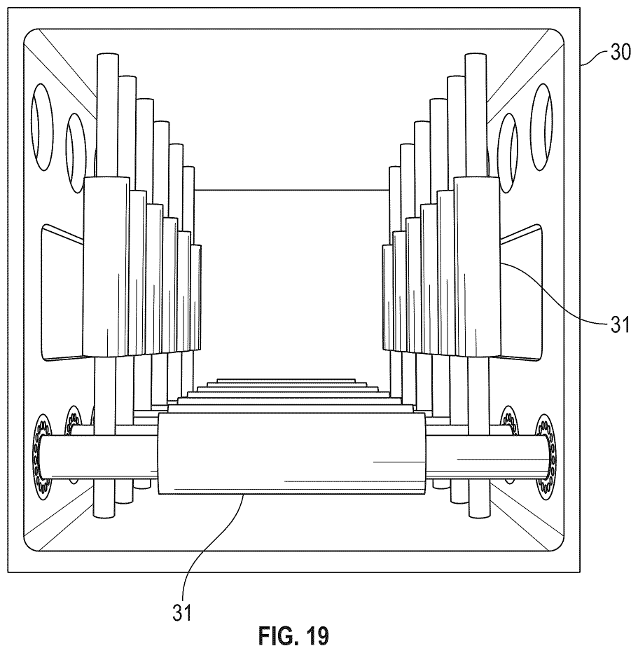

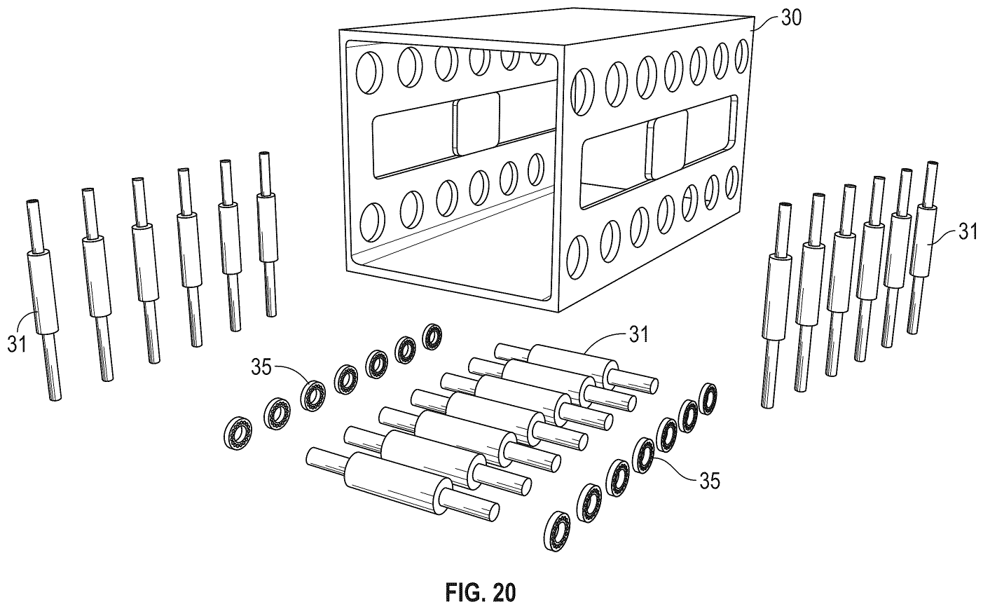

In another similar embodiment shown in FIGS. 14-20, a square or rectangular cage 30 is used to receive and hold the cable or cable conduit with cylindrical or longitudinal interior rollers 31 on the interior sides of the cage and below the cable or cable conduit in the cage 30 as shown in FIGS. 14-20, but not with cylindrical or longitudinal interior rollers 31 above the cable as for Cage 29. Cage 30 is also supported on the mobile unit 14 of the apparatus of the invention with supports 16 as shown FIGS. 14-16. These supports 16 can also raise and lower and/or tilt cage 30, as discussed further below.

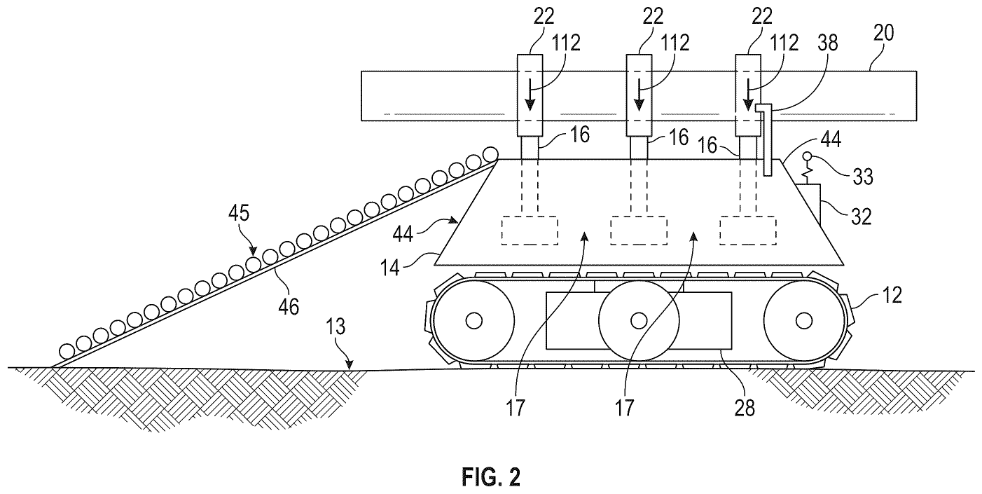

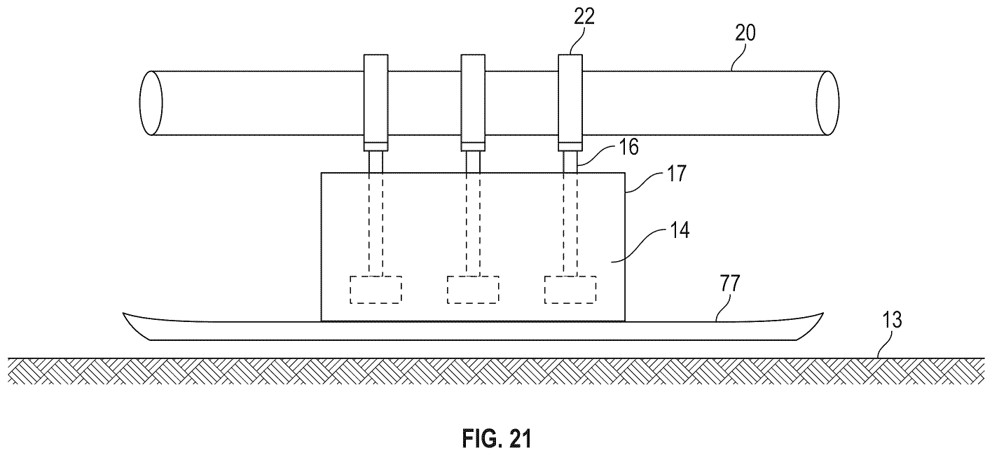

In an alternative embodiment, the cable or cable conduit holder is comprised of at least one 360 degree “O” shaped cradle 22 or similarly closed cradle such as a “D” (turned sideways)-cradle for example, and one embodiment of the apparatus of the invention has multiple such O-shaped cradle cable or cable conduit holders 22 as shown for example in FIG. 2 (which in an end view can look like or similar to the encasing cable or cable conduit holder 19 shown in FIG. 1). In the embodiment, the mobile unit 14 crosses ground on caterpillar or tank treads 12. However, in a similar embodiment, shown in FIG. 21, the mobile unit 14 crosses ground on a sled 77, and in the embodiment shown, is pulled or pushed by another apparatus or an auxiliary apparatus, as this embodiment does not have an engine.

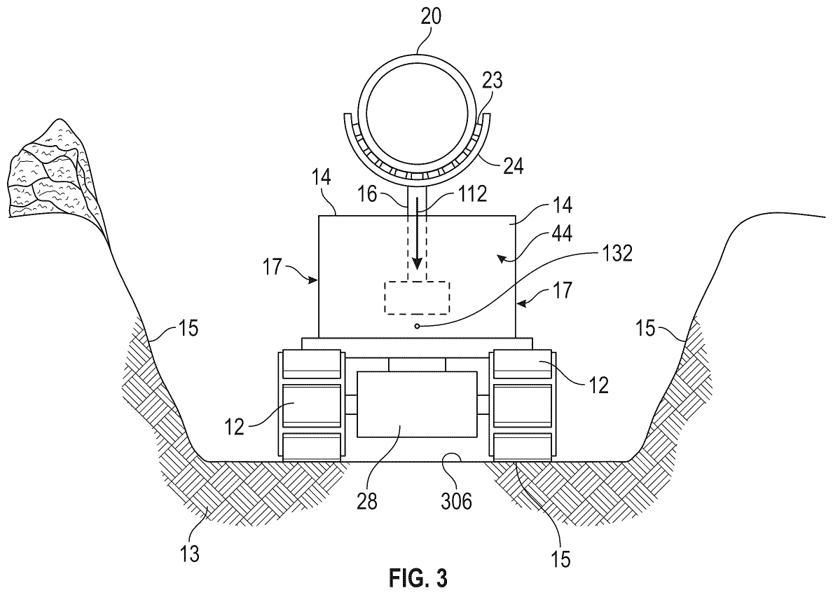

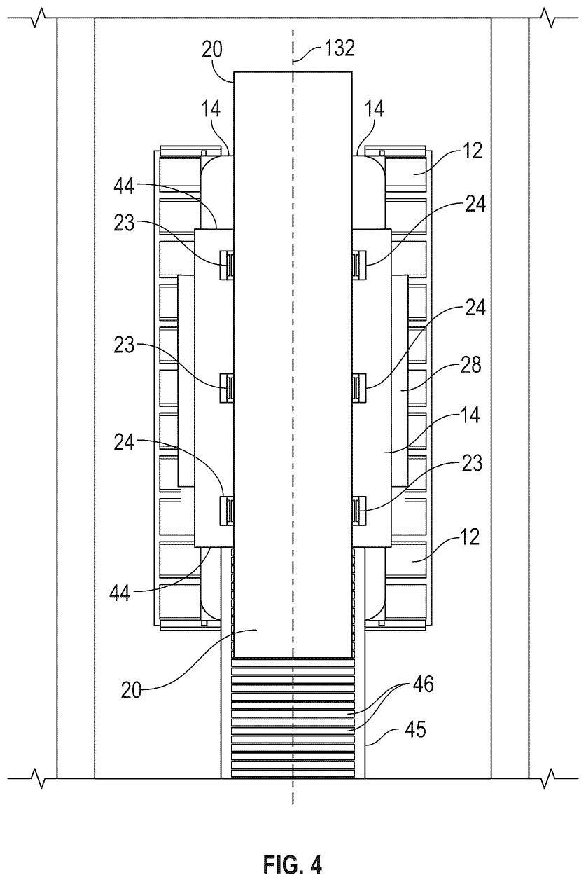

In another alternative embodiment, the cable or cable conduit holder is comprised of at least one open cup or C-shaped cradle 24 (to conform to a portion of the generally cylindrical shape of the cable or cable conduit or cable 20 or 60), with rollers 23, as shown for example in FIGS. 3 and 4. One embodiment of the apparatus of the invention has multiple such cup or C-shaped cradles 24 with rollers 23 as shown in FIGS. 3 and 4.

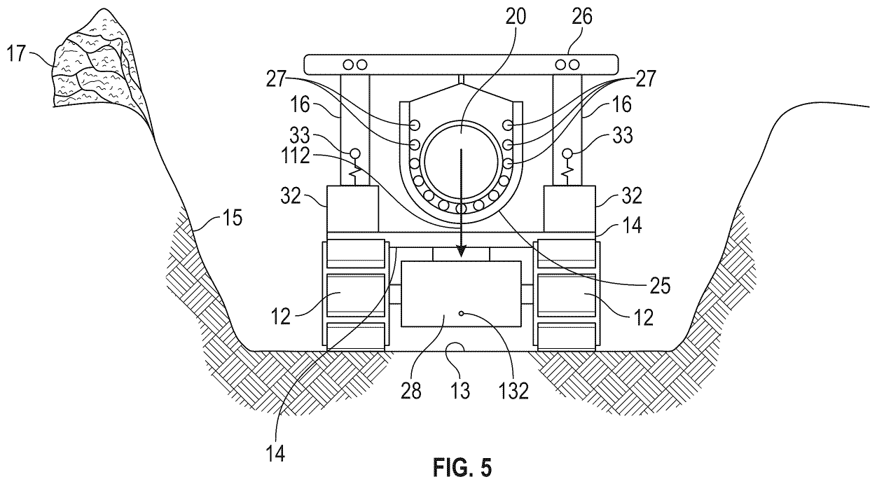

In still another embodiment, the cable or cable conduit holder is comprised of at least one horseshoe shaped cradle 25, as shown for example in FIG. 5, and one embodiment of the apparatus of the invention has multiple such horseshoe shaped cradles 25, which can be flexible as shown in FIG. 5, or not, attached to and hanging from at least one gantry or overhanging support 26 which can extend directly from mobile unit 14 or can extend from another support extending from mobile unit 14. The presence of a gantry or overhanging support 26 does not alter the purpose of cradle 25. Horseshoe shaped cradle 25, like other cable or cable conduit holders in the other embodiments, is configured to align weight 112 of cable or cable conduit 20 or 60 with the longitudinal central axis 132 as the apparatus of the invention receives or uploads, transfers and/or transports, and unloads and/or offloads the cable or cable conduit 20 or cable or 60, whether the cable or cable conduit holder is directly attached to the support 16 or hangs from a gantry or overhanging support 26.

FIGS. 2, 4, and 6-11, which show multiple cable or cable conduit holders (and multiple corresponding supports 16), show two or three such cable or cable conduit holders (and respectively two or three corresponding supports 16) for illustrative purposes. Fewer or more such cable or cable conduit holders and supports could be used with adequate success. Similarly, one or multiple supports 16 could be used for the encasement cable or cable conduit holder 19 shown in FIG. 1, or the cage cable or cable conduit holders 29 and 30 shown respectively in FIGS. 12 and 14, and multiple encasement, or cage, cable or cable conduit holders could be alternatively used.

While the Figures illustrate a one-to-one correspondence of cable or cable conduit holder to support on the mobile unit, it is also envisioned that alternatively multiple supports could support one cable or cable conduit holder, and further alternatively that multiple cable or cable conduit holders could be supported by one support.

In some of the embodiments of the apparatus of the invention, each support 16 is extensible or extendable, for example, via hydraulics or hydraulic cylinders. Because the cable or cable conduit holder (19, 22, 24, 25, 29, 30, and 78 respectively in the Figures) is attached, directly or indirectly, to the distal end of the support 16, the distance of the cable or cable conduit holder from the mobile unit 14 can be adjustable. Thus, for example, if desired, support 16 can be raised to receive a cable or cable conduit 20, or cable or cable conduit section or segment 60, onto the cable or cable conduit holder(s), or can be lowered to provide a low profile for transport.

When multiple supports 16 are used, the supports 16 should preferably be independently extensible or extendable so that they can be extended in different amounts—one support 16 with respect to the other support 16—when desired so as to cause the cable or cable conduit to tilt as opposed to be held parallel to the mobile unit. Such tilt, as will be discussed further below, can be used to facilitate offloading of the cable or cable conduit from the mobile unit in certain applications or uses of the apparatus.

When only one support 16 is used, such support 16 can be adapted to itself tilt or to have associated with it a tiltable or tilt-causing attachment so that the support 16 can cause the cable or cable conduit to tilt as opposed to being held parallel to the mobile unit when desired, or the mobile unit itself can be adapted to lift, lower, and/or tilt. During transport, however, the cable or cable conduit will usually preferably be held parallel to the mobile unit.

A level sensor, associated with controller 32, senses the horizontal position of mobile unit 14 as the apparatus traverses the ground. If the ground is uneven, the level sensor can send signals to the one or more supports 16 and adjust the extension length of each support such that a cable or cable conduit or cable or cable conduit segment or cable or cable conduit section supported by a cable or cable conduit holder on or attached to or extending from or integrated with the support stays horizontally level despite uneven terrain that the apparatus is traversing.

In an alternative embodiment, the mobile unit 14 is itself extensible or extendable and can tilt (at either end 44 of the apparatus rather than at either lateral side 17 of the apparatus) to raise or lower the cable or cable conduit holder(s) and their support(s) 16. In this embodiment, the level sensor associated with controller 32 can send signals to the mobile unit 14 to raise, lower, or tilt the mobile unit 14 and cause the cable or cable conduit holder(s) and cable or cable conduit 20 or 60 to be raised or lowered or tilted respectively thereby.

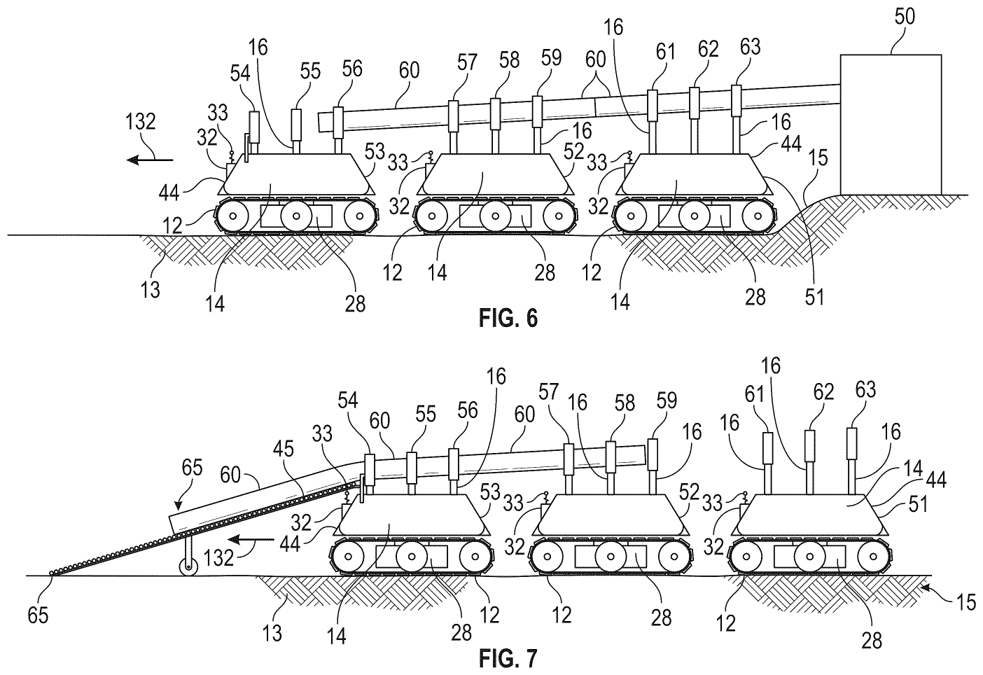

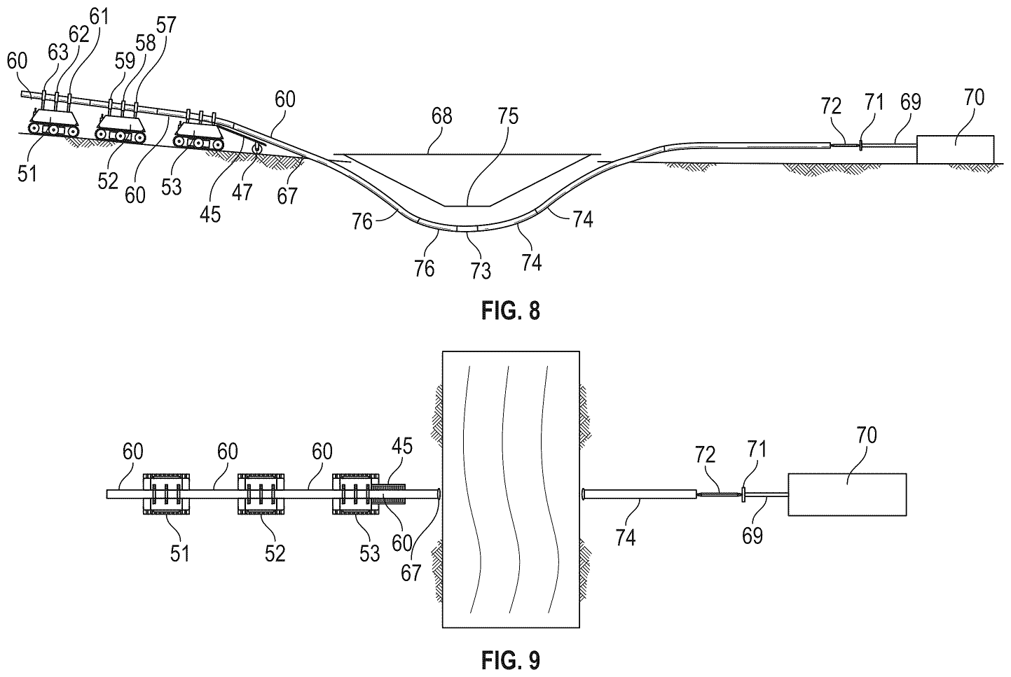

Each cable or cable conduit holder can include a low-friction surface, such as rollers 21, 23, 27, and 31, as shown in FIGS. 1, 3, 5, and 10-20, respectively, or lubrication in order to facilitate movement of cable or cable conduit 20, or cable or cable conduit segment or section 60, through or onto the cable or cable conduit holder for receipt or uploading of the cable or cable conduit 20, or cable or cable conduit segment or section 60, onto the mobile unit and for transfer and unloading and/or offloading of the cable or cable conduit 20, or cable or cable conduit segment or section 60, from the mobile unit of the apparatus to another apparatus, as shown for example in FIG. 6, or to the location of cable or cable conduit delivery, such as respectively in the bottom of a trench as shown in FIG. 7, or on a cable or cable conduit collection site or supply unit for use in directional or horizontal drilling, as shown for example with respect to laying cable under a riverbed in FIGS. 8 and 9, which will be discussed further below.

As a result of such low friction surface of the cable or cable conduit holder, cable or cable conduit 20, or cable or cable conduit segment or section 60, is free to move relative to the cable or cable conduit holder and to the mobile unit 14 unless restrained in some manner. Brake 38, as shown in FIG. 2, provides one example for such restraint. In this embodiment, brake 38, attached to mobile unit 14 and/or to at least one of the cable or cable conduit holders, secures cable or cable conduit 20, or cable or cable conduit segment or section 60, relative to mobile unit 14. When brake 38 is engaged, cable or cable conduit 20, or cable or cable conduit segment or section 60, is no longer free to move relative to the cable or cable conduit holder and mobile unit 14.

The apparatus of the invention can optionally include a ramp 45, as shown for example in FIGS. 2, 4, 7, 8, 9, and 11, which is preferably attachable at either end 44 of the apparatus of the invention, that is the front or the back of the apparatus, which in most embodiments of the apparatus of the invention will look similar, as shown in FIGS. 2, 4, and 6-11. Also in most embodiments of the apparatus of the invention, the front end and the back end of the apparatus can be used interchangeably or vice versa.

Unless specifically indicated otherwise herein, reference to an “end” of the apparatus of the invention means either end--the front end or the back end and vice versa. Thus end 44 in FIG. 2 is at either the front or the back of the embodiment of the apparatus of the invention shown in FIG. 2, and the end views of the embodiments of the apparatuses of the invention shown in FIGS. 1, 3, and 5 can be either the front end or the back end of the apparatuses and vice versa.

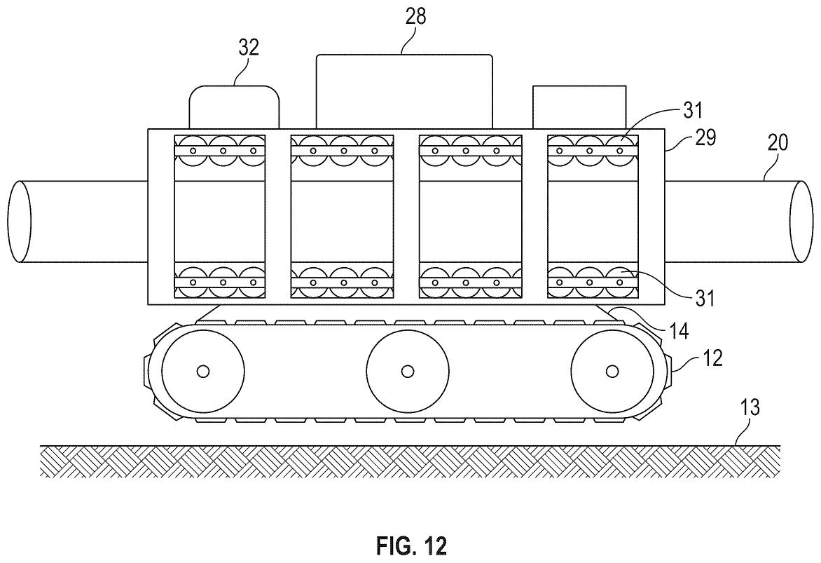

When attached to an end 44 of the apparatus for use, and particularly to the mobile unit 14 at said end 44, ramp 45 extends from said mobile unit 14 to the location that the cable or cable conduit 20, or cable or cable conduit segment or section 60, on the mobile unit 14 is to be unloaded and/or offloaded and laid or deposited, such as, for non-limiting examples, the floor of a trench or ditch for cable or cable placement 65 as shown in FIG. 7, or on a cable or cable conduit collection site such as in FIG. 11, or for use with directional drilling near a feed site 67 such as shown in FIG. 8 where directional drilling is used to place a cable or cable conduit under a river 68.

When unloading or offloading cable or cable conduit from mobile unit 14, cable or cable conduit 20 slides down ramp 45 until said cable or cable conduit 20 is in contact with the surface of the desired deposit location. Ramp 45 includes a low-friction surface. The low-friction surface of ramp 45 can be lubricated or can include slides or rollers 46, as shown for example in FIGS. 2 and 4. For example, rollers 46 can include ball bearings, spherical rollers, or cylindrical shaped rollers. Cylindrical shaped rollers can have a diameter in the range of, for example, 1 to 12 inches. Larger or smaller diameters are also contemplated. The low-friction surface of ramp 45 can further include bumpers or a V-shaped surface to direct the cable or cable conduit or cable or cable conduit segment 45 to the longitudinal middle of ramp 45.

Ramp 45 can also include a wheel 47 attached to the underside of ramp 45 as shown in FIGS. 7 and 8. The wheel 47 supports or helps support the weight of the ramp 45 and the cable or cable conduit 20, or cable or cable conduit segment or section 60, when the cable or cable conduit 20, or cable or cable conduit segment or section 60, is offloading from the mobile unit 14 down ramp 45. Such wheel 47 is sized such that it vertically positions the end of the ramp 45 proximate the deposit location for the cable or cable conduit 20, such as for example, a floor of a trench or ditch, or the feed site location 67 for use with cable or cable conduit line placement employing directional drilling under a river 68 or body of water as shown in FIGS. 8 and 9. The wheel 47 can optionally include a wiper (not shown). The wiper would rub the wheel to remove mud, clay, or dirt that could possibly collect on the wheel.

Although it is contemplated that ramp 45, which is optional, can be used for unloading or offloading cable or cable conduit 20, or cable or cable conduit segment or section 60, from mobile unit 14, ramp 45 can in one embodiment also be used for uploading or receiving cable or cable conduit 20, or cable or cable conduit segment or section 60, for holding and transporting the cable or cable conduit 20, or cable or cable conduit segment or section 60, on mobile unit 14.

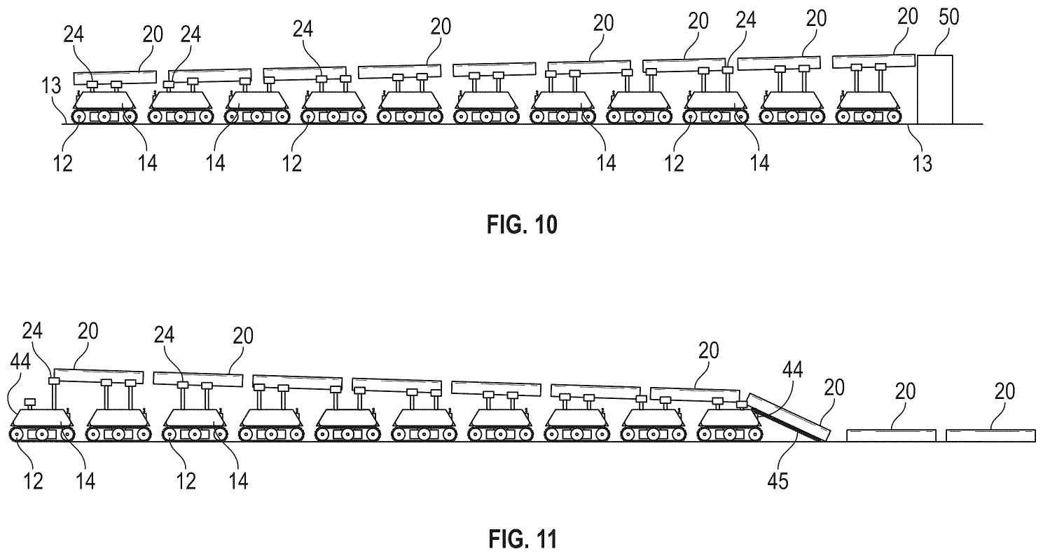

Usually, however, the cable or cable conduit holder of the apparatus of the invention will receive a cable or cable conduit 20, or cable or cable conduit segment or section 60, directly from a cable or cable conduit source, as shown for example in FIGS. 6 and 10, or similar cable or cable conduit source, or from another apparatus of the invention, as shown for example in FIGS. 6-11. Transfer of cable or cable conduits between apparatuses of the invention do not require or need use of ramp 45 when the apparatuses are positioned in tandem adjacent to one another or in sufficient proximity to one another that the cable or cable conduit can reach in a transfer from one apparatus to the other without risk of sag.

The apparatus of the invention comprising a mobile unit receives power to be mobile from engine 28. That is, the caterpillar track or tank treads 12, powered by engine 28, provide mobility for the apparatus and its mobile unit 14. Engine 28 can be designed to operate on diesel fuel, gasoline, hydrogen, other green fuels, electrical batteries, solar powered batteries, etc. or any combination thereof.

Controller 32 enables remote operation and control of the apparatus, and can also specifically manage operation of mobile unit 14, engine 28, caterpillar tracks or tank treads 12, support(s) 16, brake 48, and when used, ramp 45. Controller 32 can be remote controlled and can be programmable. Controller 32 is mounted on the apparatus or in electrical communication with these various controllable components of the apparatus. A user can program controller 32 through the use of a remote computer or direct wired computer to operate and manage the apparatus, including the mobile unit 14, engine 32, caterpillar track or tank treads 12, support(s) 16, brake 48, and ramp 45. To manage the aforementioned components means to send signals as desired from a processor to servers or other mechanical component(s) to effect movement in the mobile unit 14, engine 32, caterpillar track or tank treads 12, support(s) 16, brake 48, and when used ramp 45.

In an illustrative example, controller 32 can be programmed to position an apparatus of the invention, or to position a plurality of apparatuses of the invention, for specific parameters of the cable or cable conduit 20 and the intended cable or cable conduit line location, such as for example a trench or ditch, or alternatively on a right away or in association with directional underground drilling (such as for cable or cable conduit line placement under a river or other body of water). That is, for further example, each apparatus can be programmed to move into position based on size and weight of cable or cable conduit 20, or cable or cable conduit segment or section 60, length and depth of the trench or ditch, or number of apparatuses in use in such trench or ditch, as shown for non-limiting examples in FIGS. 6-11.

The position of one apparatus of the invention with respect to another apparatus of the invention during operation of laying cable or cable conduits at the location for underground installation, particularly in transferring a cable or cable conduit from one apparatus of the invention to an adjacent apparatus of the invention, is important in order to control sag of the cable or cable conduit being transported and transferred and to prevent damage to the cable or cable conduit.

Controller 32 includes antenna 33 which may enable a user to drive the apparatus of the invention, and control the caterpillar tracks or tank treads 12, engine 28, mobile unit 12, support(s) 16, and ramp 45 when used, with a remote controller. Controller 32 can also control signals sent from a level sensor to support(s) 16. In one embodiment, controller 32 can also control signals sent from a level sensor to mobile unit 14 where mobile unit 14 can be raised or lowered or tilted in addition to or instead of raising or lowering support(s) 16.

Controller 32 can be implemented, for example, as custom circuitry, as hardware, a hardware processor executing programmed instructions, a processor implementing software, a processor implementing firmware, or some combination thereof. Dedicated hardware elements may be referred to as “processors,” “controllers,” or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, a control element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

An apparatus of the invention comprising a mobile unit can be used alone and independently of other apparatuses of the invention, or can be used in cooperation with a plurality of like or similar apparatuses of the invention comprising mobile units and/or auxiliary units. An apparatus of the invention can receive, transfer and/or carry or transport, and deliver and unload and/or offload a single cable or cable conduit, or in cooperation with another adjacent apparatus of the invention in sufficient proximity that a single cable or cable conduit can extend at least in part over the respective mobile units of both apparatuses and can be supported in at least one cable or cable conduit holder of at least one of the two apparatuses. In another application, multiple apparatuses of the invention can be positioned in tandem, end-to-end, in such close proximity that a cable or cable conduit can be received from one adjacent apparatus and transported or transferred to another adjacent apparatus. In still another embodiment, multiple apparatuses of the invention can be positioned in end-to-end tandem and in such close proximity that a single cable or cable conduit 20, having multiple cable or cable conduits segments or sections 60 welded together, can be carried and transported by those multiple apparatuses working together, as shown for example in FIGS. 6 and 7. In all such applications, the apparatuses of the invention maintain the cable or cable conduit in parallel alignment with the longitudinal central axes 132 of the apparatuses and during receipt, transfer, transport and unloading or offloading of the cable or cable conduit.

FIGS. 6 and 7 illustrate how the ability of the apparatuses of the invention to work together serially in receiving, transferring, transporting and delivering cable or cable conduit can be effectively used in laying cable or cable conduit for underground installation. This illustration further takes advantage of or demonstrates the small size of the apparatuses of the invention, and their ability to essentially go where a cable or cable conduit can go—in a trench or ditch cut for placement of a cable or cable conduit. FIGS. 6 and 7 show apparatuses of the invention transporting a cable or cable conduit 20, or cable or cable conduit segment or section 60, from a source of cable or cable conduit, to a delivery location 65 in a trench or ditch 15 for intended placement of the cable or cable conduit 20, or cable or cable conduit segment or section 60, for comprising a portion of the cable or cable conduit to be laid in the ditch by three cooperating apparatuses of the invention, apparatuses 51, 52, and 53 respectively. These apparatuses are positioned in a line relative to each other such that the longitudinal central axis 132 of each is collinear one apparatus with respect to the other apparatus. The apparatuses are shown in a trench or ditch 15 but could just as easily be on a right away or on the side above the ditch or even on a utility roadway, for example. In other words, the apparatuses of the invention are versatile due to their size and structure and can generally move about on a cable or cable conduit installation site without departing from the established right-or-way or easement for the cable or cable conduit installation.

As shown in FIG. 6, a first apparatus of the invention 51 receives at one end 44 the initial portion of cable or cable conduit segment or section 60, from the source 50 of cable or cable conduit, and transfers this portion of cable or cable conduit 60 at apparatus 51's other end 44 to adjacent apparatus 52, who receives that first portion of cable or cable conduit 60 while apparatus 51 receives the second portion of cable or cable conduit 60. Apparatus 52 then transfers that first portion of cable or cable conduit 60 to adjacent apparatus 53 while apparatus 52 receives the second portion of cable or cable conduit 60 and apparatus 51 receives the third and final portion of cable or cable conduit 60

With cable or cable conduit 60 thus fully loaded on apparatuses 51, 52 and 53 and secured in the cable or cable conduit holders 61, 62, 63, and 57, 58, 59, and 54, 55, 56 on the respective apparatuses 51, 52, and 53, and with said apparatuses having maintained the cable or cable conduit 60 in alignment with the longitudinal central axes 132 of the apparatuses and their respective mobile units 14 during such receipt and transfer, the apparatuses 51, 52, and 53 in cooperation together transport 60 to the delivery location in the trench 65 while continuing to maintain the cable or cable conduit segment or section 60 in alignment with the longitudinal central axes 132 of the respective apparatuses.

At the delivery location in the trench 65, as shown in FIG. 7, while continuing to maintain the cable or cable conduit segment or section 60 in alignment with the longitudinal central axis 132 of the respective apparatuses, apparatus 51, the most distal to the delivery location in the trench 65, raises the support 16 for the cable or cable conduit holder 63 and thus raises cable or cable conduit holder 63 higher than the other cable or cable conduit holders on any of the three apparatuses. Apparatus 51 also about simultaneously similarly raises the cable or cable conduit holder 62 the next highest and cable or cable conduit holder 61 the next highest. At about the same time, adjacent apparatus 52 similarly raises the cable or cable conduit holder 59 to be the next highest, and cable or cable conduit holder 57 to be the next highest, and cable or cable conduit holder 56 to be the next highest. Also at about the same time, apparatus 53, the most proximal to the delivery location in the trench 65, releases ramp 45 to extend out to delivery location 65 and raises cable or cable conduit holder 56, 54, and 54 with each raised less than the one before such that cable or cable conduit holder 54 is raised the least (or not at all) so the cable or cable conduit holders on the three apparatuses decrease serially and substantially simultaneously in height as they near or after they reach the delivery location 65. This gradual change in the height of the cable or cable conduit holders causes cable or cable conduit segment or section 60 to be higher at its distal end with respect to the delivery location 65 and gravity urges cable or cable conduit segment or section 60 to begin transfer from apparatus 53 to ramp 45 for unloading off apparatus 53 and to begin transfer from apparatus 52 to apparatus 53 and from apparatus 51 to apparatus 52. Apparatus 51 can move away from apparatus 52 as cable or cable conduit segment or section 60 unloads off apparatus 51. The transfer and movement of cable or cable conduit segment or section 60 continues toward the ramp 45 and apparatus 52 can move away as cable or cable conduit segment or section 60 unloads off apparatus 52. Apparatus 53 similarly can move away as the final portion of cable or cable conduit segment or section 60 unloads off apparatus 53 and the entire cable or cable conduit segment or section 60 is laid at delivery location 65. Throughout the receipt, transfer, transport and delivery, the weight of the cable or cable conduit segment or section 60 is aligned with the longitudinal central axes 132 of the apparatuses supporting it.

The incline for unloading of the cable or cable conduit should be sufficiently gradual, and the number of apparatuses sufficient for adequate proximity one to another for controlled transfer and delivery of the cable or cable conduit, so that such transfer and delivery of the cable or cable conduit occurs without sag and the cable or cable conduit is otherwise not damaged during the process.

The principals of the method and application of use of the apparatuses described with respect to FIGS. 6 and 7 can be similarly applied for transporting multiple cable or cable conduits or cable or cable conduit segments or cable or cable conduit sections to a cable or cable conduit holding unit for use in cable or cable conduit placement at certain locations, such as under a body of water using directional drilling equipment as shown in FIGS. 8 and 9, or for delivering multiple cable or cable conduit to a cable or cable conduit location for connecting cable or cable conduits at that location, and avoiding transport of longer cable or cable conduit sections.

That is, the above described method or procedure illustrated in FIGS. 6 and 7 can be effectively repeated in the method or procedure illustrated in FIGS. 8 and 9, but for delivery and downloading of cable or cable conduit 20, or cable or cable conduit segment or section 60, into a delivery location 67 that is a feed port for using directional drilling for taking and laying cable or cable conduit under a river 68 rather than the actual surface where the cable or cable conduit section will be laid for installing the cable or cable conduit underground.

Referring to FIGS. 8 and 9, apparatuses 51, 52, and 53 again work in tandem to deliver cable or cable conduit segment or section 60 to the delivery location 67. Cable or cable conduit segment or section 60 is then welded to another cable or cable conduit segment or section 60 to be taken under the river 68 where both cable or cable conduit segments or sections 60 will be taken by carrier cable or cable conduit 76 being pulled underground under the bottom of the river 75 by drilling rig 70 and placed under that bottom of the river 75 to connect to the cable or cable conduit on the opposing side of the river. More than two cables or cable conduits segments or sections 60 may be needed for that connection, depending on the width and depth of the river 68, but the cables or cable conduits segments or sections should be connected together before being taken by carrier cable or cable conduit 76 underground under the bottom of the river 75. The carrier cable or carrier cable conduit 76 and the cable or cable conduit segment or section 60 are preceded by a cutter/shaver 71, a swivel 72, a reamer 74, and a guide 73, also all pulled by the drilling rig 70, to make, secure, and lubricate the hole for pulling and placement of the cable or cable conduit segment or section 60 under the river 68.

In another embodiment of this method, apparatuses of this invention are also used to first deliver cable or cable conduit 20 to a cable or cable conduit storage unit near the delivery location 67. From this cable or cable conduit storage unit, the cable or cable conduit or cable 20 can be connected to cable or cable conduit 60 and then loaded onto apparatuses of the invention. The apparatuses then transport and deliver the cable or cable conduit to the delivery location 67 as above described.

While these FIGS. 6 and 7 and 8 and 9 illustrate cooperative use of three apparatuses of the invention for transport and delivery of a cable or cable conduit, the principal of operation is similarly effective for multiple cable or cable conduits. Further, such cooperation can be accomplished with each apparatus carrying its own load rather than sharing a load, and transferring its load to the adjacent apparatus for delivery of a number of cable or cable conduits in series or in sequence. Such illustrations are but examples of the physical implementations for a plurality of apparatuses of the invention, particularly with respect to transporting and laying cable or cable conduits for underground installation.

Although three apparatuses are depicted in the examples of FIGS. 6 and 7, and FIGS. 8 and 9, the number of apparatuses needed for transporting and laying cable or cable conduits for underground installation is determined by the number of cable or cable conduits to be delivered, the dimensions of the cable or cable conduit, and the type/intended use of the cable or cable conduit. Additional or fewer apparatuses can be used, including without limitation for uses such as the ones discussed above and illustrated in FIGS. 6 and 7 and 8 and 9.

FIGS. 10 and 11 illustrate another embodiment of the method of the invention employing a plurality of apparatuses for transporting multiple cables or cable conduits 20 for underground installation. In this embodiment, a plurality of the cable or cable conduit laying apparatuses of the invention are positioned in a line, end to end (i.e., tandem), at a source for or feeder of cable or cable conduit 20 for the cable or cable conduit line. As with many embodiments of the invention, each apparatus of the invention is weighted and configured to carry one cable or cable conduit 20, or one cable or cable conduit segment or section 60.

In FIGS. 10 and 11, the first apparatus, that is, the apparatus most proximate the cable or cable conduit source 50 receives from the cable or cable conduit source 50 a first cable or cable conduit 20 onto the cable or cable conduit holders on the supports 16 on the mobile unit 14 of that first apparatus.

This first apparatus then transfers that first cable or cable conduit from said mobile unit to the mobile unit of a second apparatus adjacent to said first apparatus, while accepting or receiving a second cable or cable conduit 20 from the cable or cable conduit source 50. The second apparatus transfers the first cable or cable conduit 20 to a third apparatus adjacent the second apparatus and distal the first apparatus, while the first apparatus transfers the second cable or cable conduit 20 to the second apparatus and the first apparatus receives a fourth cable or cable conduit 20 from the cable or cable conduit source 50. The apparatuses in the line continue to receive and reciprocally transfer cable or cable conduit 20 down the line until all the apparatuses in the line are holding a cable or cable conduit 20, including the apparatus most distal the cable or cable conduit source 50, as shown in FIG. 10.

Once loaded with cable or cable conduit 20, the apparatuses in line move in tandem to the location for delivering and laying the cable or cable conduit 20, which is typically a cable or cable conduit holding unit near the site the cable or cable conduit is to be laid and installed underground, or the cable or cable conduit site itself, and in this illustration is a cable or cable conduit holding unit from which the cable or cable conduit 20 will be connected to other cable or cable conduit 20 for placement and underground installation.

As shown in FIG. 11, at the location for delivering and laying the cable or cable conduit 20, each apparatus, again arranges in a line, end to end. The apparatus on the end of the line most proximal the location for delivering and laying the cable or cable conduit 20 then extends or attaches ramp 45 at its end 44 most proximal the location for delivery and moves the cable or cable conduit 20 it is carrying down ramp 45 to unload the cable or cable conduit 20 at that delivery location.

About the same time, the apparatus adjacent this most proximal apparatus causes the cable or cable conduit 20 it is carrying to offload to that most proximal apparatus, which in turn moves that cable or cable conduit 20 down the ramp 45. Also at about the same time, each apparatus in line reciprocates, moving its cable or cable conduit 20 forward toward the adjacent apparatus in the direction of the most proximal apparatus causing said most proximal apparatus to continue to unload each cable or cable conduit 20 down the ramp 45 for deposit at the delivery location. Once the apparatus at the distal end of the line is no longer holding a cable or cable conduit 20, as that apparatus is not positioned in the direction to receive a cable or cable conduit 20 from an adjacent apparatus, the apparatus leaves the line.

Once said cable or cable conduit on the apparatuses have been delivered or laid for underground installation, the apparatuses return to the cable or cable conduit source 50 to repeat these steps until the cable or cable conduit 20 delivery desired for the underground installation is complete.

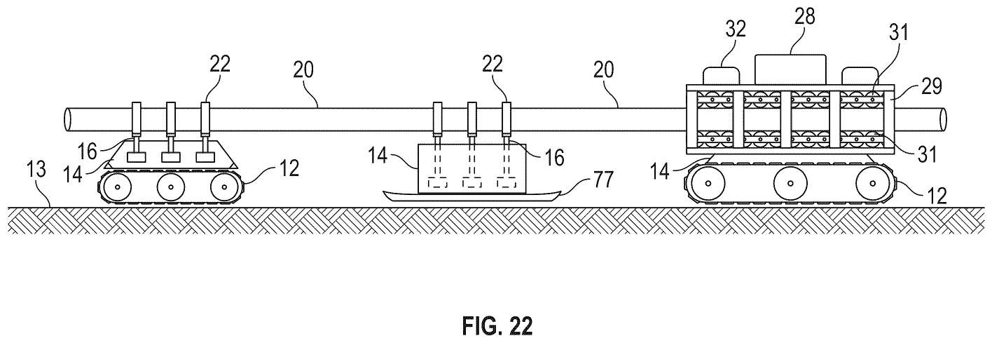

FIG. 22 is a schematic of three apparatuses of the invention that can be used in tandem with each other in various configurations in methods of the invention, that is, with several of one adjacent in line and then another in line, rather than exactly as or substantially similar to one and then the other and then the third one as shown in FIGS. 6-11 for example. In this FIG. 22, the second or middle apparatus differs from the first and third apparatuses shown in that the second or middle apparatus is not independently maneuverable, i.e., it has no battery or engine for movement but rather is pulled or pushed along by the first apparatus and/or the third apparatus. This second or middle apparatus (similar to the apparatus in FIG. 21), thus has a sled base to make it easier to push and/or pull and still has cable or cable conduit holders 22 that can be raised or lowered so as to support and facilitate receiving, transport and delivery of cable or cable conduit 20, or cable or cable conduit segment or section 60. The first apparatus shown in FIG. 22 is similar to the embodiment shown in FIG. 2 and the third apparatus shown in FIG. 22 is similar to the apparatus shown in FIG. 12, discussed above. FIG. 22 is but one example of the many various configurations possible with the apparatuses and methods of the invention, depending on the needs possibly dictated by the terrain and location to which the cable or cable conduit is to be laid, among other factors such as costs, timing and availability of various apparatuses.

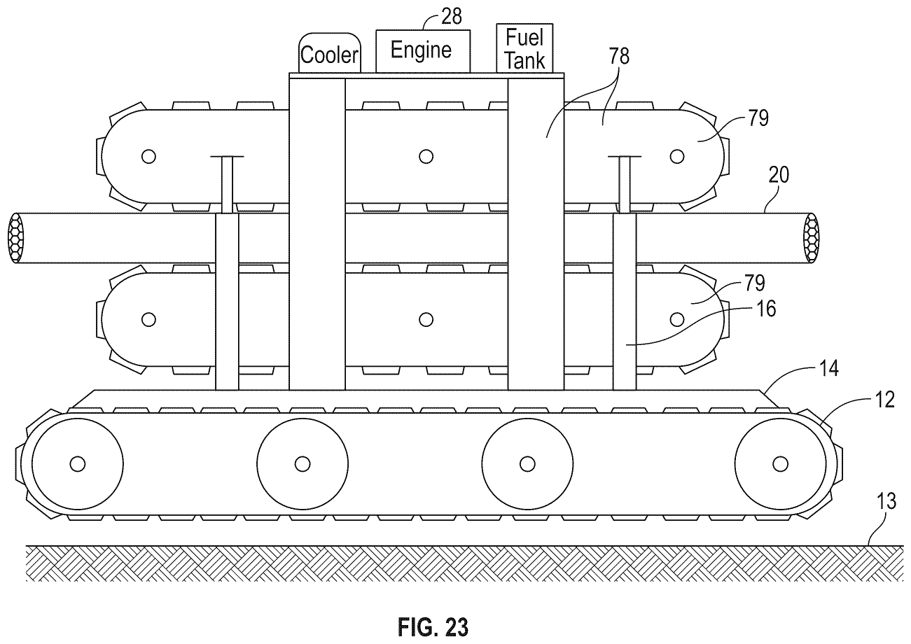

Similarly, many more variations of the apparatus of the invention can be contemplated with similar or even identical functionality as described herein. One such example is shown in FIG. 23. The embodiment of the apparatus of the invention in FIG. 23 has a caterpillar or tank treads 12, a mobile unit 14, supports 16, and a tensioner style cable or cable conduit holder 78 comprised of a pair of parallel and overlying rollable treads 79 for holding cable or cable conduit by sandwiching it between the rollable treads 79. At least one of the rollable treads 79 can be raised or lowered with respect to the other rollable tread 79 so that the distance between the rollable treads 79 accommodates cable or cable conduit having various diameters. The rollable treads when not rolling can thus hold the cable or cable conduit for transport, and can roll for receiving and offloading or unloading cable or cable conduit from the apparatus to facilitate such receiving and offloading or unloading cable or conduit by the push or pull of the cable or cable conduit caused by the rolling of the treads 79. This embodiment thus has uses in the methods of the invention as the other embodiments of the apparatus of the invention described above.

The description of the different illustrative embodiments of the present invention has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the invention, the practical application, and to enable persons of ordinary skill in the art to understand the disclosure for various embodiments with various modifications as are suited to the particular use contemplated.

### APPENDIX

### List of Elements in Drawings

12 Caterpillar tracks or tank treads
13 Soil
14 Mobile unit
15 Trench or ditch
16 Support
17 Lateral side of mobile unit
18 Dug-out soil on right of way of trench or ditch
19 Encasement cable or cable conduit holder
20 Cable or cable conduit or cable or cable conduit segment
21 Rollers
22 O-shaped cable or cable conduit holder
23 Rollers
24 C-shaped cable or cable conduit holder
25 Horseshoe shaped cable or cable conduit holder
26 Gantry
27 Rollers
28 Engine
29 Cage cable or cable conduit holder with rollers on all internal sides (top, bottom, and both lateral sides) of the cage.
30 Cage cable or cable conduit holder with rollers on the bottom and both lateral sides of the interior of the cage, but not on the top interior side of the cage.
31 Cylindrical rollers
32 Controller
33 Antenna associated with controller
35 Connectors for attaching cylindrical rollers to cage cable or cable conduit holder
38 Brake
44 End (interchangeable front end or back end of apparatus and mobile unit of the apparatus)
45 Ramp
46 Rollers on ramp
47 Wheel on ramp
50 Cable or cable conduit source
51 One embodiment of an apparatus of the invention
52 One embodiment of an apparatus of the invention like apparatus 51
53 One embodiment of an apparatus of the invention like apparatus 51
54 One embodiment of a cable or cable conduit holder on apparatus 53
55 One embodiment of a cable or cable conduit holder on apparatus 53, like cable or cable conduit holder 54
56 One embodiment of a cable or cable conduit holder on apparatus 53, like cable or cable conduit holder 54
57 One embodiment of a cable or cable conduit holder on apparatus 52, like cable or cable conduit holder 54
58 One embodiment of a cable or cable conduit holder on apparatus 52, like cable or cable conduit holder 54
59 One embodiment of a cable or cable conduit holder on apparatus 52, like cable or cable conduit holder 54
60 Cable or cable conduit section
61 One embodiment of a cable or cable conduit holder on apparatus 51, like cable or cable conduit holder 54
62 One embodiment of a cable or cable conduit holder on apparatus 51, like cable or cable conduit holder 54
63 One embodiment of a cable or cable conduit holder on apparatus 51, like cable or cable conduit holder 54
65 Delivery location in trench for cable or cable conduit placement
67 Delivery location at river for cable or cable conduit
68 River
69 Drill cable or cable conduit
70 Drilling rig
71 Cutter/shaver
72 Swivel
73 Guide
74 Reamer
75 River bottom
76 Carrier cable or cable conduit
77 Sled or skid
78 Tensioner style cable or cable conduit holder
79 Pair of parallel and overlying rollable treads for the tensioner style cable or cable conduit holder 78
112 Weight of cable or cable conduit
132 Longitudinal central axis of apparatus of invention

What is claimed is:

1. A cable or cable conduit transporting and laying apparatus for transporting and laying at a delivery location a cable or cable conduit for underground installation, comprising:
a mobile unit having a longitudinal central axis and a front end and a rear end for receiving and unloading the cable or cable conduit onto and off of the mobile unit, wherein said front end and said rear end can be used interchangeably;
at least one support configured to align a weight of the cable or cable conduit with said longitudinal central axis upon receiving, holding, transporting and unloading the cable or cable conduit at said delivery location;
at least one cable or cable conduit holder with a low-friction surface extending from or associated with said at least one support for facilitating said receiving, holding, transporting and unloading of said cable or cable conduit at said delivery location;
caterpillar track or tank treads to carry and move said apparatus;
an engine or motor configured to drive said caterpillar track or tank treads; and
a programmable controller for controlling movement of said apparatus remotely.

2. The apparatus of claim 1 wherein the footprint of said apparatus is no more than six inches greater than the diameter of the cable or cable conduit the apparatus carries.

3. The apparatus of claim 1 further comprising:
an optional ramp for attaching to said front end or said back end of said mobile unit to aid the uploading or unloading of the cable or cable conduit.

4. The apparatus of claim 1 wherein at least a length of at least one support is adjustable such that a height position of the at least one support or the at least one cable or cable conduit holder relative to the mobile unit is adjustable.

5. The apparatus of claim 1 wherein the cable or cable conduit holder comprises a casement-type holder for said cable or cable conduit.

6. The apparatus of claim 5 wherein said casement type holder surrounds the external diameter of said cable or cable conduit with rollers for at least a portion of the length of said cable or cable conduit.

7. The apparatus of claim 1 wherein the cable or cable conduit holder comprises a cage type holder for said cable or cable conduit.

8. The apparatus of claim 7 wherein said cage type holder has cylindrical rollers on at least the internal sides and bottom of said cage.

9. The apparatus of claim 1 wherein the cable or cable conduit holder comprises a C-shaped holder for said cable or cable conduit.

10. The apparatus of claim 1 wherein the cable or cable conduit holder comprises a horseshoe shaped holder for said cable or cable conduit.

11. The apparatus of claim 1 wherein the cable or cable conduit holder comprises an O-shaped or D-shaped holder for said cable or cable conduit.

12. The apparatus of claim 1 wherein said low-friction surface of said cable or cable conduit holder comprises rollers positioned to be adjacent at least a portion of said cable or cable conduit to be held in said holder.

13. The apparatus of claim 1 wherein said caterpillar track or tank treads comprise natural or synthetic rubber on their surface contacting soil in use.

14. The apparatus of claim 1 wherein said mobile platform is extensible.

15. The apparatus of claim 1 further comprising an associated auxiliary engineless vehicle which said apparatus pulls or pushes for holding and transporting cable or cable conduit, wherein said auxiliary engineless vehicle comprises:
a mobile unit having a longitudinal central axis and a front end and a rear end for receiving and unloading cable or cable conduit onto and off of the mobile unit, wherein said front end and said rear end can be used interchangeably;
at least one support configured to align a weight of the cable or cable conduit with said longitudinal central axis upon receiving, holding, transporting and unloading the cable or cable conduit at said delivery location;
at least one cable or cable conduit holder with a low-friction surface extending from or associated with said at least one support for facilitating receiving from said apparatus and holding, transporting and unloading of said cable or cable conduit;
sled or caterpillar track or tank treads to carry and move said auxiliary engineless vehicle when pushed or pulled by said apparatus.

16. The apparatus of claim 1 further comprising wheels or skids which can be substituted for said caterpillar tracks or tank treads.

17. A method of transporting a cable or cable conduit and laying a cable or cable conduit for underground installation at a delivery location using more than one apparatus of claim 1 acting in cooperation one with the other, the method comprising:
positioning said more than one apparatus in a line relative to each other in tandem, end to end formation, such that the longitudinal central axis of each is collinear one apparatus with respect to the other apparatus(es), and in sufficient proximity one to the other such that said cable or cable conduit can extend from said one apparatus to at least said one other of said apparatus(es) such that said cable or cable conduit does not sag between the apparatuses and such that said cable or cable conduit is supported by at least one cable or cable conduit holder on at least one support on the unit of each said one apparatus and at least said one other of said apparatus(es), while allowing said apparatuses sufficient distance between one another that they can each move without hitting the other, and then placing said cable or cable conduit on said apparatuses accordingly;
moving said apparatuses toward said delivery location;
unloading said cable or cable conduit at said delivery location by unloading the portion of said cable or cable conduit on one apparatus while that said one apparatus receives the adjacent portion of said cable or cable conduit offloaded from said adjacent apparatus, and repeating said transfer of any other portions of said cable or cable conduit on any other of said apparatuses until the cable or cable conduit is completely delivered at said delivery location.

18. The method of claim 17 wherein said delivery location is in the floor of a trench or ditch.

19. The method of claim 17 wherein said delivery location is at the mouth of a feed hole for introducing the cable or cable conduit for placement underground using carrier pipe and a drilling rig.

20. A method of transporting a cable or cable conduit and laying a cable or cable conduit for underground installation at a delivery location using a plurality of apparatuses of claim 1, the method comprising:
(a) positioning at least a first apparatus, a second apparatus and a third apparatus from said plurality of apparatuses in a line relative to each other in tandem such that the longitudinal central axis of each is collinear one apparatus with respect to the other apparatus;
(b) the first of said apparatuses in said line receiving a first cable or cable conduit, or cable or cable conduit segment or section, onto at least one cable or cable conduit holder on at least one support on the mobile platform of said first of said apparatuses, while aligning and maintaining alignment of a weight of the cable, cable conduit or cable segment or section or cable conduit segment or section, with said longitudinal central axis of said first of said apparatuses;
(c) said first of said apparatuses transferring said first cable or cable conduit, or cable or cable conduit segment or section, to the second of said apparatuses in said line adjacent to said first apparatus, said second of said apparatuses receiving said first cable or cable conduit, or cable or cable conduit segment or section, onto at least one cable or cable conduit holder on at least one support on the mobile platform of said second of said apparatuses, while aligning and maintaining alignment of a weight of cable or cable conduit, or cable or cable conduit segment or section, with said longitudinal central axis of said second of said apparatuses, while said first of said apparatuses receives a second cable or cable conduit, or a second cable or cable conduit segment or section, onto at least one cable or conduit holder on at least one support on the mobile platform of said first of said apparatuses, while aligning and maintaining alignment of a weight of the cable or cable conduit, or cable or cable conduit segment or section, with said longitudinal central axis of said first of said apparatuses;
(d) said second of said apparatuses transferring said first cable or cable conduit, or said first cable or cable conduit segment or section, to the third of said apparatuses in said line adjacent to said second apparatus, said third of said apparatuses receiving said first cable or cable conduit, or said first cable or cable conduit segment or section, onto at least one cable or cable conduit holder on at least one support on the mobile platform of said third of said apparatuses, while aligning and maintaining alignment of a weight of the cable or cable conduit, or cable or cable conduit segment or section, with said longitudinal central axis of said third of said apparatuses, while said second of said apparatuses receives a second cable or cable conduit, or cable or cable conduit segment or section, onto at least one cable or cable conduit holder on at least one support on the mobile platform of said second of said apparatuses, while aligning and maintaining alignment of a weight of the cable or cable conduit, or cable or cable conduit segment or section, with said longitudinal central axis of said second of said apparatuses; while said first of said apparatuses receives a third cable or cable conduit, or cable or cable conduit segment or section, onto at least one cable or cable conduit holder on at least one support on the mobile platform of said first of said apparatuses, while aligning and maintaining alignment of a weight of cable or cable conduit, or cable or cable conduit segment or section, with said longitudinal central axis of said first of said apparatuses, while aligning and maintaining alignment of a weight of the cable or cable conduit, or cable or cable conduit segment or section, with said longitudinal central axis of said first of said apparatuses;
(e) continuing the reciprocal receiving and transferring of additional cable or cable conduit, or cable or cable conduit segment or section, of steps (b)-(d) among or along the line of the plurality of apparatuses until each of said apparatuses is holding a cable or cable conduit, or cable or cable conduit segment or section;
(f) moving said line of the plurality of apparatuses toward the delivery location, with each said apparatus maintaining alignment of a weight of the cable or cable conduit, or cable or cable conduit segment or section it is carrying with said longitudinal central axis of that apparatus;
(g) upon the plurality of apparatuses arriving at the delivery location, positioning said apparatuses in line relative to each other in tandem such that the longitudinal central axis of each is collinear one apparatus with respect to the other apparatus;
(h) having the apparatus most proximal the delivery location unload the cable or cable conduit, or cable or cable conduit segment or section, on its mobile platform at the delivery location, while receiving from the next most proximal and adjacent apparatus the cable or cable conduit, or cable or cable conduit segment or section, on its mobile platform;
(i) continuing said transfer of cable or cable conduit, or cable or cable conduit segment or section, from each apparatus to an adjacent apparatus in the line of plurality of apparatuses with said most proximal apparatus unloading each upon receipt at the delivery location until said most proximal apparatus has unloaded at said delivery location all cable or cable conduit, or cable or cable conduit segments or sections, that were carried by the plurality of apparatuses.
